(19) United States
(12) Patent Application Publication
(10) Pub. No.: US 2025/0188254 A1
(43) Pub. Date: Jun. 12, 2025

(54) RUBBER COMPOSITION FOR WHITE SIDEWALL COVER RUBBER AND PNEUMATIC TIRE

(71) Applicant: Toyo Tire Corporation, Itami-shi (JP)

(72) Inventor: Kanae Abe, Itami-shi (JP)

(73) Assignee: Toyo Tire Corporation, Itami-shi (JP)

(21) Appl. No.: 18/951,847

(22) Filed: Nov. 19, 2024

(30) Foreign Application Priority Data
Dec. 8, 2023 (JP) 2023-207445

(51) Int. Cl. C08L 7/00; B60C 1/00; C08K 5/098; C08K 5/20; C08L 9/00

(52) U.S. Cl. CPC C08L 7/00; B60C 1/0025; C08K 5/098; C08K 5/20; C08L 9/00; C08L 2205/035; C08L 2205/06

(57) ABSTRACT

The rubber composition for a white sidewall cover rubber according to the embodiment contains rubber components and a wax in which 100 parts by mass of the rubber components contain 20 to 60 parts by mass of a natural rubber and 10 to 40 parts by mass of a butadiene rubber and in which the amount of the wax is 2 to 7 parts by mass based on 100 parts by mass of the rubber components.

### BACKGROUND OF THE INVENTION

### 1. Field of the Invention

The present invention relates to a rubber composition for a white sidewall cover rubber and a pneumatic tire using the same.

### 2. Description of Related Art

For the purpose of improving the visibility and the design of tires, white sidewalls in which patterns such as letters and symbols formed on the sidewalls are composed of a white rubber composition are known. A white sidewall may be formed as follows. For example, an unvulcanized black rubber for forming the sidewall is divided at a predetermined part in the radial direction, and a white rubber is placed in the gap. A black cover rubber layer is formed on the white rubber, and thus a green tire is formed. The green tire is vulcanized in a predetermined mold, and then, a part of the cover rubber layer is ground to expose the white rubber in a pattern.

As a technique related to white sidewalls, for example, JP2016-777A discloses that specific amounts of titanium oxide, a wax, and a farnesene polymer are added to rubber components containing a natural rubber, a butyl rubber, and an ethylene propylene diene rubber to improve the balance of white evenness and resistance to color change.

JP2011-6516A discloses that predetermined amounts of a white inorganic filler and a phenol compound having an alkylthiomethyl group are added to a rubber component to improve the initial and aged whiteness and the aging resistance.

### SUMMARY OF THE INVENTION

It was found that, in the white sidewalls above, the black cover rubber placed on the white rubber sometimes whitens with time and that the appearance is thus impaired. As disclosed in JP2016-777A and JP2011-6516A, techniques for improving the white evenness and the resistance to color change of the white rubber have been known, but no technique for suppressing whitening of the cover rubber that covers the white rubber has been known.

In view of the above point, an object of an embodiment of the invention is to provide a rubber composition for a white sidewall cover rubber which can suppress whitening of the cover rubber in a white sidewall.

The invention includes the embodiments shown below.

[1]A rubber composition for a white sidewall cover rubber containing rubber components and a wax, wherein 100 parts by mass of the rubber components contain 20 to 60 parts by mass of a natural rubber and 10 to 40 parts by mass of a butadiene rubber, and the amount of the wax is 2 to 7 parts by mass based on 100 parts by mass of the rubber components.

[2] The rubber composition for a white sidewall cover rubber according to [1] which further contains a processing aid containing a fatty acid derivative.

[3] The rubber composition for a white sidewall cover rubber according to [1] or [2], wherein the cis-1,4 bond content of the butadiene rubber is 90% or more.

[4] The rubber composition for a white sidewall cover rubber according to any one of [1] to [3], wherein 100 parts by mass of the rubber components contain 25 to 50 parts by mass of the natural rubber and 10 to 35 parts by mass of the butadiene rubber.

[5] The rubber composition for a white sidewall cover rubber according to any one of [1] to [4], wherein 100 parts by mass of the rubber components further contain 0 to 40 parts by mass of a butyl rubber and/or a halogenated butyl rubber and 10 to 30 parts by mass of an ethylene propylene diene rubber.

[6]A pneumatic tire having a white sidewall cover rubber formed with the rubber composition according to any one of [1] to [5].

According to the embodiments of the invention, a rubber composition for a white sidewall cover rubber which suppresses whitening of the cover rubber in a white sidewall and which has excellent appearance and excellent ozone resistance can be provided.

### BRIEF DESCRIPTION OF THE DRAWINGS

FIG. 1 is a half section view of the pneumatic tire according to an embodiment.

FIG. 2 is an enlarged section view of the main parts of the pneumatic tire in FIG. 1.

### DESCRIPTION OF EMBODIMENTS

The rubber composition for a white sidewall cover rubber according to the embodiment (also called “cover rubber composition” below) contains rubber components and a wax. A hundred parts by mass of the rubber components contain 20 to 60 parts by mass of a natural rubber (NR) and 10 to 40 parts by mass of a butadiene rubber (BR), and the amount of the wax is 2 to 7 parts by mass based on 100 parts by mass of the rubber components.

When the butadiene rubber is used with the natural rubber as a rubber component in this manner, whitening of the cover rubber surface in a white sidewall can be suppressed. Although the mechanism is not intended to be limited thereto, this is speculated to be because, when the butadiene rubber is blended, precipitation of the components which migrate to the tire surface such as the wax is suppressed and because whitening due to the precipitation is suppressed. Moreover, when the predetermined amount of the wax is added, the ozone resistance becomes excellent while the excellent appearance obtained by blending the butadiene rubber is maintained.

In the cover rubber composition, the rubber components contain the natural rubber (NR) and the butadiene rubber (BR) as described above. In 100 parts by mass of the rubber components, the natural rubber content is 20 to 60 parts by mass, and the butadiene rubber content is 10 to 40 parts by mass. With the contents, the appearance and the physical property (tear strength) can be both obtained. More preferably, 100 parts by mass of the rubber components contain 25 to 50 parts by mass of the natural rubber and 10 to 35 parts by mass of the butadiene rubber.

The butadiene rubber is a polymer of butadiene and may be a high-cis butadiene rubber (high-cis BR) or a low-cis butadiene rubber (low-cis BR). Preferably, for improving the effect of obtaining both the appearance and the physical property (tear strength), high-cis BR having a cis-1,4 bond content of 90% or more is used. The high-cis BR is obtained, for example, by polymerizing 1,3-butadiene using a cobalt catalyst or a neodymium catalyst. The cis-1,4 bond content of the butadiene rubber is more preferably 95% or more. Here, the cis-1,4 bond content is a value calculated by the integral ratio of a ¹HNMR spectrum.

In the cover rubber composition, the rubber components preferably contain an ethylene propylene diene rubber (EPDM) together with the natural rubber and the butadiene rubber and more preferably contain EPDM and a butyl rubber (IIR) and/or a halogenated butyl rubber. Specifically, 100 parts by mass of the rubber components preferably contain, together with the natural rubber and the butadiene rubber, 0 to 40 parts by mass of a butyl rubber and/or a halogenated butyl rubber and 10 to 30 parts by mass of an ethylene propylene diene rubber.

In an embodiment, 100 parts by mass of the rubber components may contain 20 to 60 parts by mass of the natural rubber, 10 to 40 parts by mass of the butadiene rubber, 10 to 35 parts by mass of the butyl rubber and/or the halogenated butyl rubber, and 10 to 30 parts by mass of the ethylene propylene diene rubber. Alternatively, 100 parts by mass of the rubber components may contain 25 to 50 parts by mass of the natural rubber, 10 to 35 parts by mass of the butadiene rubber, 15 to 30 parts by mass of the butyl rubber and/or the halogenated butyl rubber, and 10 to 25 parts by mass of the ethylene propylene diene rubber. Alternatively, 100 parts by mass of the rubber components may contain 25 to 40 parts by mass of the natural rubber, 25 to 35 parts by mass of the butadiene rubber, 20 to 30 parts by mass of the butyl rubber and/or the halogenated butyl rubber, and 10 to 20 parts by mass of the ethylene propylene diene rubber.

Examples of the halogenated butyl rubber include chlorobutyl rubber (CIIR) and bromobutyl rubber (BIIR). Either one thereof may be used, or the combination thereof may be used.

The rubber components of the cover rubber composition may contain another rubber in addition to the natural rubber, the butadiene rubber, the butyl rubber and/or the halogenated butyl rubber, and the ethylene propylene diene rubber as long as the effects of the embodiment are not impaired. Examples of the other rubber include diene rubbers such as a synthetic isoprene rubber (IR), a styrene butadiene rubber (SBR), a nitrile rubber (NBR), and a chloroprene rubber (CR).

A wax is contained in the cover rubber composition as described above. A wax which is generally used for a rubber composition for a tire can be used as the wax, and examples thereof include petroleum waxes such as paraffin wax and microcrystalline wax.

The wax content, based on 100 parts by mass of the rubber components, is 2 to 7 parts by mass. When the wax content is 2 parts by mass or more, the ozone resistance can be improved. When the wax content is 7 parts by mass or less, whitening can be suppressed, and the appearance can be improved. The wax content, based on 100 parts by mass of the rubber components, is more preferably 3 to 7 parts by mass, further preferably 4 to 6 parts by mass.

A processing aid containing a fatty acid derivative is preferably further added to the cover rubber composition. When the fatty acid-based processing aid is contained, the dispersibility of the added components improves, and the appearance can be further improved. The processing aid content may be a general addition amount of a processing aid and may be, for example, based on 100 parts by mass of the rubber components, 0.1 to 5 parts by mass or 0.5 to 3 parts by mass.

The fatty acid derivative may be a fatty acid metal salt, a fatty acid amide, or a fatty acid ester. Any one kind thereof may be used, or two or more kinds thereof may be used in combination. The fatty acid metal salt may be a metal salt of a saturated fatty acid and/or an unsaturated fatty acid. The metal salt may be an alkali metal salt such as a sodium salt, an alkaline earth metal salt such as a calcium salt, a transition metal salt such as a zinc salt, or a combination use thereof. The fatty acid amide may be a primary amide such as stearic acid amide, a secondary amide such as a fatty acid ethanolamide, or a tertiary amide, and the fatty acid thereof may be a saturated fatty acid and/or an unsaturated fatty acid. The fatty acid ester is an ester of a saturated fatty acid and/or an unsaturated fatty acid and an alcohol, and the alcohol may be a monohydric alcohol or a di- or higher-hydric alcohol.

The processing aid preferably contains a fatty acid metal salt and is more preferably (1) a fatty acid metal salt or (2) a mixture of a fatty acid metal salt and a fatty acid amide and/or a fatty acid ester, further preferably (1) a fatty acid metal salt or (2′) a mixture of a fatty acid metal salt and a fatty acid amide.

Carbon black is preferably added to the cover rubber composition as a reinforcing filler and as a colorant for blackening. As the carbon black, various known kinds can be used. Specific examples thereof include SAF grade (N100 series), ISAF grade (N200 series), HAF grade (N300 series), FEF grade (N500 series), GPF grade (N600 series), and SRF grade (N700 series) (these are ASTM grade). Any one kind of the carbon black of the grades or a combination of two or more kinds thereof can be used.

The carbon black content is not particularly limited but is, based on 100 parts by mass of the rubber components, preferably 10 to 60 parts by mass, more preferably 20 to 50 parts by mass, further preferably 30 to 40 parts by mass.

An additive which is generally used for a rubber composition, such as stearic acid, zinc oxide, an antioxidant, an oil, a vulcanizing agent, and a vulcanization accelerator, may be added to the cover rubber composition as an optional component in addition to the above components.

The stearic acid content is not particularly limited and may be, for example, based on 100 parts by mass of the rubber components, 0 to 10 parts by mass, 0.5 to 5 parts by mass, or 1 to 4 parts by mass.

The zinc oxide content is not particularly limited and may be, for example, based on 100 parts by mass of the rubber components, 0 to 10 parts by mass, 1 to 8 parts by mass, or 3 to 7 parts by mass.

As the antioxidant, a non-staining antioxidant such as a phenol-based antioxidant is preferably used. The antioxidant content is not particularly limited and may be, for example, based on 100 parts by mass of the rubber components, 0 to 10 parts by mass, 0.5 to 8 parts by mass, or 1 to 5 parts by mass.

The oil content is not particularly limited and may be, for example, based on 100 parts by mass of the rubber components, 0 to 10 parts by mass, 0.5 to 8 parts by mass, or 1 to 5 parts by mass.

As the vulcanizing agent, sulfur is preferably used. The vulcanizing agent content is not particularly limited but may be, based on 100 parts by mass of the rubber components, 0.1 to 5 parts by mass, 0.3 to 3 parts by mass, or 0.5 to 2 parts by mass.

Examples of the vulcanization accelerator include various vulcanization accelerators such as sulfenamide-based, guanidine-based, thiuram-based, and thiazole-based vulcanization accelerators, and any one kind thereof alone or a combination of two or more kinds thereof can be used. The vulcanization accelerator content is not particularly limited but is, based on 100 parts by mass of the rubber components, preferably 0.1 to 7 parts by mass, more preferably 0.5 to 5 parts by mass, and may also be 1 to 4 parts by mass.

The cover rubber composition can be produced by kneading using a generally used mixer such as a Banbury mixer, a kneader, and a roll according to a general method. That is, for example, the additives excluding the vulcanizing agent and the vulcanization accelerator are added to and mixed in the rubber components in a first mixing stage (non-productive kneading process). Next, the vulcanizing agent and the vulcanization accelerator are added to and mixed in the obtained mixture in a final mixing stage (productive kneading process). As a result, an unvulcanized cover rubber composition can be prepared.

The cover rubber composition is used for covering a white rubber in a pneumatic tire having a white sidewall, and a cover rubber layer (namely, a white sidewall cover rubber) is formed with the rubber composition on the white rubber.

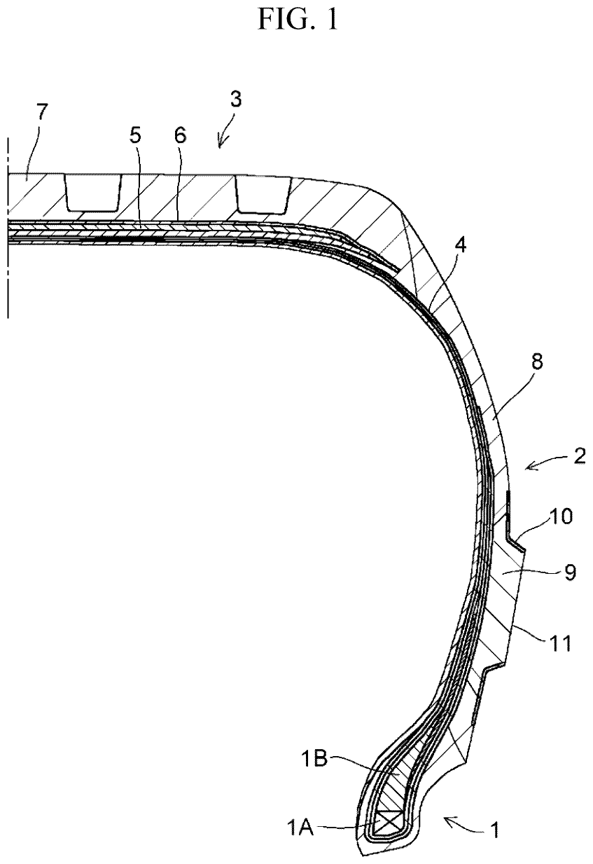

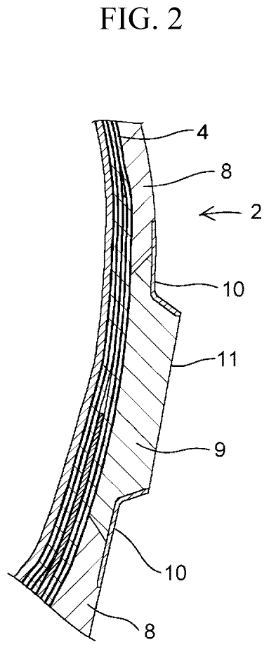

FIG. 1 and FIG. 2 are section views of a pneumatic tire showing an example thereof. The pneumatic tire has a pair of bead parts 1 and a pair of sidewalls 2 on the right and left sides, and a tread 3 which is laid between the sidewalls. In the bead part 1, a circular bead core 1A and a bead filler 1B made of rubber on the outside thereof in the radial direction are embedded. A carcass ply 4 is placed in a toroidal shape between the pair of bead cores 1A on the right and left sides, and the ends of the carcass ply 4 are locked at the bead cores 1A. A belt layer 5 and a belt-reinforcing layer 6 are provided on the outer surface of the carcass ply 4 in the tread 3, and a tread rubber 7 is provided on the outside thereof. Moreover, a sidewall rubber 8 is provided on the outside of the carcass ply 4 in the sidewall 2.

The sidewall rubber 8 is a rubber having a black color filled with carbon black. In this example, a part of the sidewall rubber 8 is replaced with a white rubber 9 having a white color. The white rubber 9 is provided circularly along the circumference direction on a part of the sidewall 2 in the radial direction. The white rubber 9 is placed in a gap formed by dividing the black sidewall rubber 8 at a predetermined part in the radial direction. The white rubber 9 does not have to be provided in both sidewalls 2 on the right and left sides but may be provided only on the side which becomes the outer side of a vehicle when the tire is mounted on the vehicle. As the rubber composition forming the white rubber 9, a known white rubber composition which is generally used for the application can be used, and the rubber composition is not particularly limited.

As shown enlarged in FIG. 2, a cover rubber layer 10 is placed to cover the surface of the sidewall 2 around the white rubber 9. The cover rubber layer 10 is formed with the cover rubber composition. The thickness of the cover rubber layer 10 is not particularly limited and may be, for example, 2 mm or less or 0.1 to 1.5 mm.

The cover rubber layer 10 is a black rubber layer having the same color as that of the sidewall rubber 8. Because the cover rubber layer 10 covers a part of the white rubber 9, the exposed part of the uncovered white rubber 9 displays predetermined information to be displayed such as a pattern, a letter, a symbol, and a design as information to be displayed in white on the outer surface of the tire. A white letter part 11 which is the exposed part of the white rubber 9 displaying the information to be displayed projects out on the outer surface of the tire. The white letter part 11 may be provided circularly and continuously in the circumference direction of the tire or provided discontinuously along the circumference direction based on the shape of the information to be displayed.

The method for forming such a white sidewall structure is not particularly limited. For example, an unvulcanized black rubber composition for forming the sidewall rubber 8 is divided at a predetermined part in the radial direction, and an unvulcanized white rubber composition for forming the white rubber 9 is placed in the gap. Then, an unvulcanized rubber tape composed of a cover rubber composition is placed on the white rubber composition. Except for the above points, a green tire is produced according to a general method by assembling with other tire materials, and the green tire is vulcanized and formed in a predetermined mold. At this point, the green tire is vulcanized and formed using a mold having a corresponding concavity so that the part corresponding to the white letter part 11 projects out from the tire surface. After the vulcanization and the forming, the black cover rubber layer 10 composed of the cover rubber composition is ground in the projected part to expose the white rubber 9, and thus information to be displayed in white is displayed on the tire surface.

According to the embodiment, while excellent ozone resistance is obtained, whitening of the cover rubber layer 10 with time is suppressed, and the black color can be maintained. Accordingly, the displayed information in white in the white letter part 11 can be highlighted for a long period of time.

The tire according to the embodiment is not particularly limited, and examples thereof include pneumatic tires of various sizes for various applications, such as tires of passenger cars and large-sized tires of trucks and busses.

### EXAMPLES

Examples are shown below, but the invention is not limited to these Examples.

The details of the raw materials used in the Examples and the Comparative Examples are as follows.
NR: natural rubber, SIR20
IIR-Cl: chlorobutyl rubber, “Chlorobutyl 1066” manufactured by Japan Butyl Co. Ltd.
EPDM: “EP33” manufactured by JSR Corporation
High-cis BR: cis-1,4 bond content of 97%, “BR150B” manufactured by UBE Corporation
Low-cis BR: cis-1,4 bond content of 32%, “Diene NF35” manufactured by Asahi Kasei Corporation
Carbon black: “Seast V” manufactured by TOKAI CARBON CO., LTD.
Stearic acid: “Lunac S-20” manufactured by Kao Corporation
Zinc oxide: “Zinc Oxide Type 3” manufactured by MITSUI MINING & SMELTING CO., LTD.
Wax: “OZOACE0355” manufactured by NIPPON SEIRO CO., LTD.
Antioxidant: “Antage SP-P” manufactured by Kawaguchi Chemical Industry Co., LTD.
Oil: “Process P200” manufactured by ENEOS Corporation
Processing aid 1: A mixture of a calcium salt of a natural fatty acid and a fatty acid ethanolamide, “Aflux 16” manufactured by Rhein Chemie Corporation
Processing aid 2: A mixture of calcium soap and a saturated fatty acid amide, “Struktol WB16” manufactured by S&S Co., LTD.
Processing aid 3: A zinc salt mixture of a saturated fatty acid, “Aktiplast PP” manufactured by Rhein Chemie Corporation
Vulcanization accelerator 1: “Nocceler DM-P” manufactured by OUCHI SHINKO CHEMICAL INDUSTRIAL CO., LTD.
Vulcanization accelerator 2: “VULTAC5” manufactured by ARKEMA
Sulfur: “Powder Sulfur” manufactured by Tsurumi Chemical Industry Co., ltd.

The evaluation methods in the Examples and the Comparative Examples are as follows.

### (1) Appearance:

Using a cover rubber composition, a test piece (a total thickness of 2.0 mm) having a cover rubber layer having a thickness of 0.5 mm on a white rubber having a thickness of 1.5 mm was produced. The vulcanization conditions were 160° C. for 20 minutes. The test piece was exposed to the sunlight in the open air. The surface of the test piece was visually observed before the exposure (outside exposure of 0 day) and after 40 days (outside exposure of 40 days), and the appearance was evaluated by the following 5-point scale.
5: The surface is black, and the color has scarcely changed.
4: The surface has slightly changed into white.
3: Less than a half of the entire surface has changed into white.
2: A half or more of the entire surface has changed into white.
1: The entire surface has changed into white.

### (2) Ozone Resistance:

A test piece (a thickness of 2.0 mm+0.2 mm) of a cover rubber was produced by vulcanizing a cover rubber composition at 160° C. for 20 minutes. The test piece was placed in an ozone weather meter apparatus under conditions that the test piece was elongated by 25%, and the test piece was left for 24 hours in an environment having an ozone concentration of 100 pphm at a temperature of 50° C. Then, whether cracks were formed was observed visually and with a 10× magnifier, and the ozone resistance was evaluated by the following 4-point scale.
4: No crack was found even by observation with the 10× magnifier.
3: No crack was observed with the naked eye, but cracks which could be observed with the 10× magnifier were formed.
2: Cracks of 1 mm or less were found by observation with the naked eye.
1: Cracks exceeding 1 mm were formed.

### (3) Tear Strength:

A rubber sheet (a thickness of 2.0 mm+0.2 mm) was produced by vulcanizing a cover rubber composition at 160° C. for 20 minutes. In accordance with JIS K6252:2015, a crescent piece was punched from the rubber sheet, and a cut of 0.50±0.08 mm was made in the middle of the concave part. A test piece was thus produced. Using the test piece, a tear test was conducted with a tensile tester manufactured by SHIMADZU CORPORATION at a tensile rate of 500 mm/minute, and the tear strength was measured and shown with an index, where the value of Comparative Example 1 was regarded as 100. As the index becomes higher, the tear strength becomes larger, meaning that the tear property is excellent.

Using a Banbury mixer, in accordance with the compositions (parts by mass) shown in Tables 1 and 2 below, first, the agents to be added excluding sulfur and the vulcanization accelerators were added to and kneaded in the rubber components in a first mixing stage (discharge temperature=155° C.). Next, sulfur and the vulcanization accelerators were added to and kneaded in the obtained kneaded material in a final mixing stage (discharge temperature=90° C.), and the cover rubber compositions of Examples 1 to 9 and Comparative Examples 1 to 4 were thus prepared. The appearances, the ozone resistance, and the tear strengths of the obtained cover rubber compositions were evaluated.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Composition | | | | | | | | | |
| (parts by mass) | | | | | | | | | |
| NR | 40 | 30 | 20 | 30 | 30 | 30 | 40 | 40 | 40 |
| IIR-Cl | 25 | 25 | 25 | 25 | 25 | 25 | 25 | 25 | 25 |
| EPDM | 15 | 15 | 15 | 15 | 15 | 15 | 15 | 15 | 15 |
| High-cis BR | 20 | 30 | 40 | | 30 | 30 | 20 | 20 | 20 |
| Low-cis BR | | | | 30 | | | | | |
| Carbon black | 35 | 35 | 35 | 35 | 35 | 35 | 35 | 35 | 35 |
| Stearic acid | 2 | 2 | 2 | 2 | 2 | 2 | 2 | 2 | 2 |
| Zinc oxide | 5 | 5 | 5 | 5 | 5 | 5 | 5 | 5 | 5 |
| Wax | 5 | 5 | 5 | 5 | 3 | 7 | 5 | 5 | 5 |
| Antioxidant | 3 | 3 | 3 | 3 | 3 | 3 | 3 | 3 | 3 |
| Oil | 2 | 2 | 2 | 2 | 2 | 2 | 2 | 2 | 2 |
| Processing aid 1 | 1 | 1 | 1 | 1 | 1 | 1 | | | |
| Processing aid 2 | | | | | | | | 1 | |
| Processing aid 3 | | | | | | | | | 1 |
| Vulcanization | 1 | 1 | 1 | 1 | 1 | 1 | 1 | 1 | 1 |
| accelerator 1 | | | | | | | | | |
| Vulcanization | 1 | 1 | 1 | 1 | 1 | 1 | 1 | 1 | 1 |
| accelerator 2 | | | | | | | | | |
| Powder sulfur | 0.5 | 0.5 | 0.5 | 0.5 | 0.5 | 0.5 | 0.5 | 0.5 | 0.5 |
| Evaluation | | | | | | | | | |
| Appearance | 4 | 5 | 4 | 4 | 5 | 3 | 3 | 4 | 4 |
| Ozone resistance | 4 | 4 | 4 | 4 | 3 | 4 | 4 | 4 | 4 |
| Tear strength | 105 | 98 | 80 | 95 | 95 | 100 | 103 | 101 | 103 |
| (index) | | | | | | | | | |

TABLE 2

| | Comp. | Comp. | Comp. | Comp. |
|---|---|---|---|---|
| | Ex. 1 | Ex. 2 | Ex. 3 | Ex. 4 |
| Composition (parts by | | | | |
| mass) | | | | |
| NR | 60 | 55 | 40 | 40 |
| IIR-CI | 25 | 25 | 25 | 25 |
| EPDM | 15 | 15 | 15 | 15 |
| High-cis BR | | 5 | 20 | 20 |
| Low-cis BR | | | | |
| Carbon black | 35 | 35 | 35 | 35 |
| Stearic acid | 2 | 2 | 2 | 2 |
| Zinc oxide | 5 | 5 | 5 | 5 |
| Wax | 5 | 5 | 1 | 8 |
| Antioxidant | 3 | 3 | 3 | 3 |
| Oil | 2 | 2 | 2 | 2 |
| Processing aid 1 | 1 | 1 | 1 | 1 |
| Processing aid 2 | | | | |
| Processing aid 3 | | | | |
| Vulcanization | 1 | 1 | 1 | 1 |
| accelerator 1 | | | | |
| Vulcanization | 1 | 1 | 1 | 1 |
| accelerator 2 | | | | |
| Powder sulfur | 0.5 | 0.5 | 0.5 | 0.5 |
| Evaluation | | | | |
| Appearance | 2 | 2 | 4 | 2 |
| Ozone resistance | 4 | 4 | 1 | 4 |
| Tear strength (index) | 100 | 101 | 100 | 102 |

The results are as shown in Tables 1 and 2. In Comparative Example 1, in which no butadiene rubber was added to the rubber components, the test piece whitened with time, and the appearance was impaired. In Comparative Example 2, although a part of the natural rubber was replaced with a butadiene rubber, the amount of the butadiene rubber was low, and the appearance did not improve. On the other hand, because a part of the natural rubber was replaced with a butadiene rubber in Example 1 and because the rubbers were contained in predetermined amounts, the appearance improved. As shown in Examples 2 and 3, the appearance was further improved by increasing the amount of the butadiene rubber, but there was a tendency towards a decrease in the tear strength. Considering the balance of the appearance and the physical property, a suitable amount of the butadiene rubber is 10 to 35 parts by mass.

Here, regarding the amount of the wax, in Comparative Example 3, in which the wax amount was 1 part by mass, the appearance was excellent, but the ozone resistance was poor. In Comparative Example 4, in which the wax amount was 8 parts by mass, the ozone resistance was excellent, but the appearance was poor. On the other hand, in Example 5, in which the wax amount was 3 parts by mass, the ozone resistance was improved compared to that of Comparative Example 3, and the appearance was excellent. In Example 6, in which the wax amount was 7 parts by mass, the appearance was improved while the excellent ozone resistance was maintained, compared to those of Comparative Example 4. Accordingly, in view of achieving both appearance and ozone resistance, the amount of the wax is preferably 2 to 7 parts by mass based on 100 parts by mass of the rubber components.

Regarding the kind of the butadiene rubber, the appearance and the ozone resistance could be both obtained in both Example 2 using high-cis BR and Example 4 using low-cis BR, but the effect of obtaining both appearance and tear strength (physical property) was superior in Example 2 using high-cis BR.

Regarding the processing aid, the appearance improved in Example 7 without the addition thereof, compared to that of Comparative Example 1 as the control, but the effect of the appearance was smaller than that of Example 1, to which a processing aid was added. Regarding the kind of the processing aid, equivalent effects with respect to the appearance and the ozone resistance were observed in Example 8 and Example 9, in which the kind thereof was changed, compared to those of Example 1.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

### REFERENCE SIGNS LIST

1: Bead part
2: Sidewall
3: Tread
4: Carcass ply
5: Belt layer
6: Belt-reinforcing layer
7: Tread rubber
8: Sidewall rubber
9: White rubber
10: Cover rubber layer
11: White letter part

What is claimed is:

1. A rubber composition for a white sidewall cover rubber comprising:
rubber components; and
a wax:
wherein 100 parts by mass of the rubber components contain 20 to 60 parts by mass of a natural rubber and 10 to 40 parts by mass of a butadiene rubber, and
the amount of the wax is 2 to 7 parts by mass based on 100 parts by mass of the rubber components.

2. The rubber composition for a white sidewall cover rubber according to claim 1 which further comprises a processing aid containing a fatty acid derivative.

3. The rubber composition for a white sidewall cover rubber according to claim 2, wherein the fatty acid derivative is a fatty acid metal salt.

4. The rubber composition for a white sidewall cover rubber according to claim 2, wherein the fatty acid derivative is a mixture of a fatty acid metal salt and a fatty acid amide and/or a fatty acid ester.

5. The rubber composition for a white sidewall cover rubber according to claim 1, wherein the cis-1,4 bond content of the butadiene rubber is 90% or more.

6. The rubber composition for a white sidewall cover rubber according to claim 1, wherein 100 parts by mass of the rubber components contain 25 to 50 parts by mass of the natural rubber and 10 to 35 parts by mass of the butadiene rubber.

7. The rubber composition for a white sidewall cover rubber according to claim 1, wherein 100 parts by mass of the rubber components further contain 0 to 40 parts by mass of a butyl rubber and/or a halogenated butyl rubber and 10 to 30 parts by mass of an ethylene propylene diene rubber.

8. The rubber composition for a white sidewall cover rubber according to claim 1 which further comprises carbon black, wherein the amount of the carbon black is 10 to 60 parts by mass based on 100 parts by mass of the rubber components.

9. A pneumatic tire comprising a white sidewall cover rubber formed with the rubber composition according to claim 1.
